(19) United States
(12) Patent Application Publication
(10) Pub. No.: US 2019/0362387 A1
(43) Pub. Date: Nov. 28, 2019

(54) INFORMATION PRESENTATION DEVICE, INFORMATION PRESENTATION METHOD, AND NON-TRANSITORY COMPUTER READABLE MEDIUM STORING PROGRAM

(71) Applicant: TOYOTA JIDOSHA KABUSHIKI KAISHA, Toyota-shi (JP)

(72) Inventors: Xin JIN, Nagoya-shi (JP); Taisuke TONE, Toyota-shi (JP); Atsushi KUBO, Toyota-shi (JP); Miharu HANAI, Obu-shi (JP)

(73) Assignee: TOYOTA JIDOSHA KABUSHIKI KAISHA, Toyota-shi (JP)

(21) Appl. No.: 16/379,099

(22) Filed: Apr. 9, 2019

(30) Foreign Application Priority Data
May 24, 2018 (JP) 2018-099840

(51) Int. Cl. G06Q 30/02; G01C 21/36; G01C 21/34

(52) U.S. Cl. CPC G06Q 30/0267; G06Q 30/0252; G01C 21/343; G01C 21/367; G01C 21/3697

(57) ABSTRACT

An information presentation device includes a communication unit configured to receive advertisement information associated with a destination estimated as a point to which a user travels, and a controller configured to present the advertisement information to the user before the user starts traveling. The controller is configured to restrict presentation of the advertisement information while the user is traveling more than before travel starts.

### INCORPORATION BY REFERENCE

The disclosure of Japanese Patent Application No. 2018-099840 filed on May 24, 2018 including the specification, drawings and abstract is incorporated herein by reference in its entirety.

### BACKGROUND

### 1. Technical Field

The present disclosure relates to an information presentation device that presents advertisement information, an information presentation method, and a non-transitory computer readable medium that stores a program for causing the information presentation device to execute processing.

### 2. Description of Related Art

There is a technique for presenting advertisement information of a travel route, in a route searching service that is executed by a navigation device etc. of a vehicle. For example, Japanese Patent Application Publication No. 2004-069318 (JP 2004-069318 A) describes, an advertisement presentation device that is able to estimate a travel route and present advertisement information of the estimated travel route, even when route guidance is not performed by a navigation device.

Advertising information associated with a destination such as a facility on a travel route may vary in terms of the necessity of presentation and contents to be presented etc., based on whether a user has not started traveling or is currently traveling. There is still room for improvement in the technique of the presentation of advertisement information associated with the destination in this way.

The disclosure relates to a technique for presenting advertisement information associated with the destination of the user.

### SUMMARY

A first aspect of the present disclosure relates to an information presentation device that has a communication unit configured to receive advertisement information associated with a destination estimated as a point to which a user travels, and a controller configured to present the advertisement information to the user before the user starts traveling. The controller is configured to restrict presentation of the advertisement information while the user is traveling more than before travel starts.

In the aspect described above, the controller may be configured so as not to present the advertisement information while the user is traveling.

In the aspect described above, the information presentation device may be configured so that an amount of the advertisement information presented by the controller is changed, based on whether a departure point of the user is determined as a base of the user.

In the aspect described above, the information presentation device may be configured so that the presentation of the advertisement information by the controller is stopped, when it is not determined that the departure point is the base of the user and it is estimated that the destination is a home of the user.

In the aspect described above, the information presentation device may be configured so that the amount of the advertisement information presented by the controller is increased, when it is not determined that the departure point is the base of the user and it is estimated that the destination is a home of the user.

In the aspect described above, the information presentation device may be configured so that an amount of the advertisement information presented by the controller is changed, in response to a request for the amount of the advertisement information presented to be changed, which is based on whether a departure point of the user is determined as a base of the user.

In the aspect described above, the information presentation device may be configured so that the presentation of the advertisement information by the controller is stopped, based on a request for the presentation of the advertisement information to be stopped, when it is not determined that the departure point is the base of the user and it is estimated that the destination is a home of the user.

In the aspect described above, the information presentation device may be configured so that the amount of the advertisement information presented by the controller is increased, based on a request for the amount of the advertisement information presented to be increased, when it is not determined that the departure point is the base of the user and it is estimated that the destination is a home of the user.

In the aspect described above, the controller may be configured to present the advertisement information to the user after the information presentation device starts up and until travel starts.

In the aspect described above, the controller may be configured to present a plurality of pieces of the advertisement information with different classifications at the same time.

The information presentation device of the aspect described above may have an input unit configured to receive a user input for the advertisement information, in which the controller is configured to execute, based on the user input, a process of route guidance to the destination associated with the advertisement information.

A second aspect of the present disclosure relates to an information presentation method that includes: estimating a destination of a user; receiving advertisement information associated with the destination; and presenting the advertisement information to the user before the user starts traveling. Presentation of the advertisement information while the user is traveling is more restricted than before travel starts.

A third aspect of the present disclosure relates to a non-transitory computer readable medium that stores a program for causing an information presentation device to execute processes. The processes include: receiving advertisement information associated with a destination estimated as a point to which a user travels; presenting the advertisement information to the user before the user starts traveling; and restricting presentation of the advertisement information while the user is traveling more than before travel starts.

With an information presentation device etc. of the present disclosure, it is possible to improve a technique for presenting advertisement information associated with a destination of a user.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is diagram illustrating a schematic configuration of an information presentation system according to an embodiment of the disclosure;

FIG. 2 illustrates an example of a display screen including advertisement information;

FIG. 3 is a diagram illustrating a data structure of an advertisement database;

FIG. 4 is a sequence diagram illustrating an operation of the information presentation system according to the embodiment of the disclosure; and

FIG. 5 illustrates another example of the display screen including advertisement information.

### DETAILED DESCRIPTION OF EMBODIMENTS

An embodiment of the disclosure will be described below. In the embodiment, a case in which an information presentation device 10 is used in a vehicle will be described as an example.

### Configuration of Information Presentation System

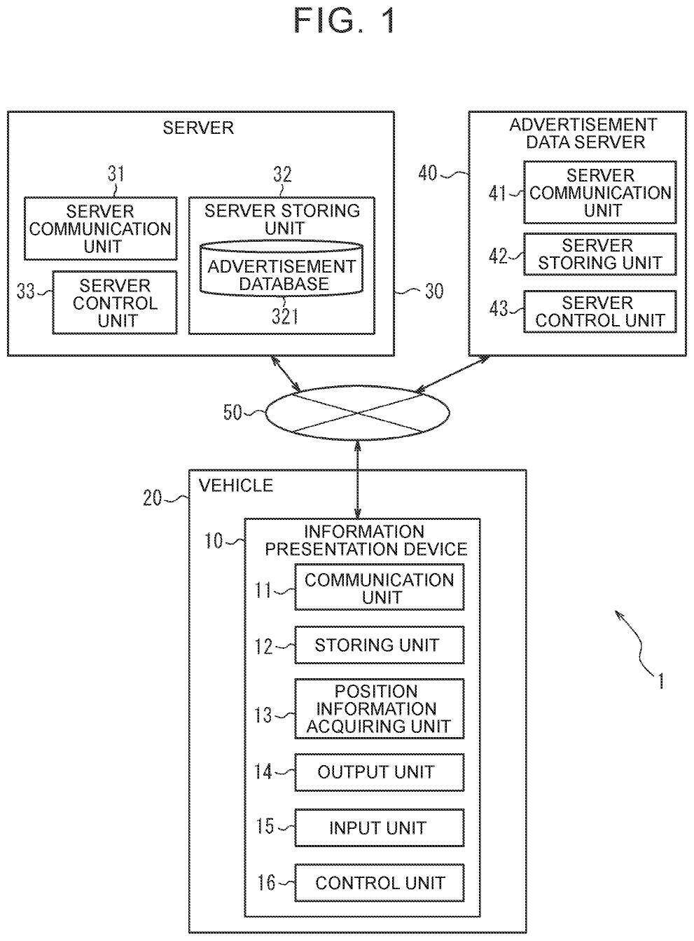

An overview of an information presentation system 1 according to the embodiment of the disclosure will be described with reference to FIG. 1. The information presentation system 1 has the information presentation device 10, a vehicle 20, a server 30, and an advertisement data server 40. The information presentation device 10, the server 30, and the advertisement data server 40 are connected to a network 50. The network 50 includes a mobile communication network and the Internet, for example. However, the network 50 is not limited to these, and may include an appropriate communication network.

The information presentation device 10 is a versatile information presentation device such as an on-board device, a smartphone, or a tablet terminal. However, the information presentation device 10 is not limited to these, and may be an appropriate terminal such as a device dedicated to the information presentation system 1. In the embodiment, the information presentation device 10 will be described as an on-board device that is installed in the vehicle 20. The vehicle 20 is an automobile, for example. However, the vehicle 20 is not limited to this, and may be any vehicle on which people can ride. The server 30 includes one server or a plurality of servers that are able to communicate with each other. In the embodiment, to simplify the description, a case in which the server 30 is one server device will be described. The advertisement data server 40 includes one server or a plurality of servers that are able to communicate with each other. In the embodiment, to simplify the description, a case in which the advertisement data server 40 is comprised of one server device will be described.

In the information presentation system 1 according to the embodiment, the information presentation device 10, the server 30, and the advertisement data server 40 collaborate to present advertisement information to a user. To summarize, the information presentation system 1 estimates a destination of the user, and presents advertisement information associated with the estimated destination to the user before the user starts traveling. The server 30 receives position information from the information presentation device 10 and estimates the destination of the user based on the position information etc. The server 30 also receives advertisement information associated with the estimated destination from the advertisement data server 40. The server 30 transmits advertisement information to the information presentation device 10 and the information presentation device 10 presents the advertisement information to the user before travel starts. Here, the information presentation device 10 restricts presentation of advertisement information while the user is traveling. Specifically, the information presentation device 10 stops presenting advertisement information while the user is traveling.

In the information presentation system 1 according to the embodiment, the information presentation device 10 presents advertisement information associated with the estimated destination to the user before travel starts and restricts presentation of advertisement information while the user is traveling. Thus, it is possible to present advertisement information before the user travels so as to assist the user traveling, and restrict presentation of advertisement information while the user is traveling to the destination so as to suppress the user from feeling uncomfortable.

Each configuration of the information presentation system 1 will be described in detail.

### Configuration of Information Presentation Device

As shown in FIG. 1, the information presentation device 10 has a communication unit 11, a storing unit 12, a position information acquiring unit 13, an output unit 14, an input unit 15, and a controller 16.

The communication unit 11 includes a communication module that is connected to the network 50. For example, the communication unit 11 may include a communication module that conforms to 4G (4th Generation) and 5G (5th Generation) mobile communication standards etc. The communication unit 11 may be a communication device such as a data communication module (DCM). In the embodiment, the information presentation device 10 is connected to the network 50 via the communication unit 11.

The storing unit 12 includes one or more memory units. In the embodiment, a “memory unit” is a semiconductor memory, a magnetic memory, or an optical memory etc. However, the “memory unit” is not limited to these. The memory units included in the storing unit 12 may function as a main storage device, an auxiliary storage device, or a cache memory, for example. The storing unit 12 stores information used for operation of the information presentation device 10. For example, the storing unit 12 may store a system program, an application program, identification information of the information presentation device 10, and identification information of the user etc. The application program includes a program for route guidance, for example. The application program may include an application dedicated to the present system. Information stored in the storing unit 12 may be updatable with information acquired from the network 50 via the communication unit 11, for example.

The position information acquiring unit 13 includes one or more receiving devices that are compatible with an appropriate satellite positioning system. For example, the position information acquiring unit 13 may include a global positioning system (GPS) receiving device. The position information acquiring unit 13 acquires position information of the information presentation device 10.

The output unit 14 includes one or more output interfaces that output information to the user. For example, an output interface included in the output unit 14 is a panel display that outputs information by images, a head-up display, or a speaker that outputs information by sounds etc. However, the output interface is not limited to these, and may be an appropriate output interface. In the embodiment, “images” may include text, still images, and moving images.

The input unit 15 includes one or more input interfaces that detect a user input. For example, an input interface included in the input unit 15 is a physical key, a capacitive key, a touchscreen that is integrally provided with the panel display of the output unit 14, or a microphone that receives voice input etc. However, the input interface is not limited to these, and may be an appropriate input interface.

The controller 16 includes one or more processors. In the embodiment, a “processor” is a general-purpose processor or a processor dedicated to a specific processing. However, the “processor” is not limited to these. The controller 16 controls the entire operation of the information presentation device 10.

For example, the controller 16 notifies the server 30 of position information of the information presentation device 10 acquired by the position information acquiring unit 13, via the communication unit 11. The server 30 is notified of position information when the information presentation device 10 starts up, that is, when an accessory power source is turned on (at ACC-ON). The server 30 may be notified of position information at an appropriate timing other than when the information presentation device 10 starts up. For example, the controller 16 may notify the server 30 at prescribed time intervals or every time the information presentation device 10 is in a specified state.

The controller 16 transmits probe data and user information to the server 30 via the communication unit 11. Probe data includes traveling history data including a traveling date and time and a position of the vehicle 20, and data of behavior history of forward/backward acceleration and left/right acceleration. User information may include operation history of a user input to the information presentation device 10, personal information of the user, and history of actions of the user.

The controller 16 receives advertisement information associated with the destination estimated by the server 30 from the server 30 via the communication unit 11. Advertisement information includes information related to a product or a service. “Advertisement information associated with the destination” includes advertisement information of a destination facility, advertisement information of a facility near the destination, and advertisement information of a facility on a route to the destination. It is possible to increase the possibility of presenting useful advertisement information to the user, by presenting advertisement information associated with the destination to the user such as a facility on a travel route.

The controller 16 determines whether the user has started traveling. This is determined based on sensor information of the vehicle 20. The controller 16 presents advertisement information to the user with the output unit 14, when travel to the destination has not started. Advertisement information is presented by at least either images or sounds.

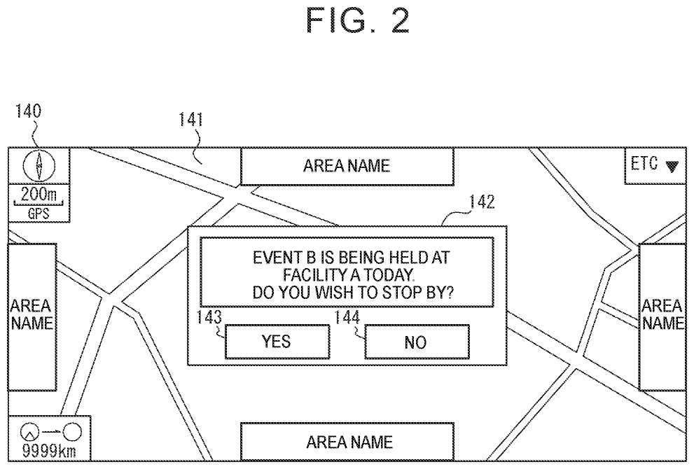

As one example of presenting advertisement information, the controller 16 may display text etc. on a screen. FIG. 2 illustrates an example of the display screen including advertisement information presented by the output unit 14. Here, a case in which the output unit 14 is a touchscreen that is integrally provided with the input unit 15 will be described. The output unit 14 displays a display screen 140, for example. The display screen 140 has route guidance information 141 including map information, and advertisement information 142. In the example illustrated in FIG. 2, advertisement information 142 includes text according to event information. Examples of event information include “Five times more points today” and “50% off sale”.

Here, the information presentation device 10 may detect actions of the user to the advertisement information 142. Actions of the user may include a user input. In order to receive the user input, the advertisement information 142 may include input buttons 143, 144 for selecting whether to stop by a facility according to advertisement information 142. When the controller 16 receives the user input, the controller 16 executes processing based on the user input. For example, the controller 16 executes route guidance processing to the destination associated with advertisement information based on the user input. In this way, it is possible to improve convenience of the present system. Based on the user input, the controller 16 may transmit a log of the user input to the server 30. The server 30 may update an advertisement database 321 described below based on the log of the user input. In this way, it is possible to present advertisement information that is suitable for the user.

If the user has started traveling, that is, while the user is traveling, the controller 16 restricts presentation of advertisement information by the output unit 14 more than before travel starts. Specifically, the controller 16 stops presentation of advertisement information by the output unit 14, while the user is traveling. In other words, the controller 16 presents advertisement information to the user, after the information presentation device 10 starts up and until travel starts. In contrast, the controller 16 does not present advertisement information by the output unit 14, while the user is traveling.

### Configuration of Server

As shown in FIG. 1, the server 30 has a server communication unit 31, a server storing unit 32, and a server controller 33.

The server communication unit 31 includes a communication module that is connected to the network 50. For example, the server communication unit 31 may include a communication module that conforms to a prescribed wired standard or wireless standard. In the embodiment, the server 30 is connected to the network 50 via the server communication unit 31.

The server storing unit 32 includes one or more memory units. The memory units included in the server storing unit 32 may function as a main storage device, an auxiliary storage device, or a cache memory, for example. The server storing unit 32 stores information used for operation of the server 30. For example, the server storing unit 32 stores information collected from the information presentation device 10 etc. For example, the server storing unit 32 also stores the advertisement database 321 described below. The server storing unit 32 may store a system program, an application program, and a management database etc. Information stored in the server storing unit 32 may be updatable with information acquired from the network 50 via the server communication unit 31, for example.

The server controller 33 includes one or more processors. The server controller 33 controls the operation of the entire server 30.

For example, the server controller 33 receives position information of the user when the information presentation device 10 starts up, from the information presentation device 10 via the server communication unit 31. The server controller 33 performs home/away determination based on the received position information. In the home/away determination, the server controller 33 determines whether a position of the user when the information presentation device 10 starts up is a base of the user (home) or is not the base of the user (away). In other words, in the home/away determination, the server controller 33 determines whether a position of the departure point of the user is the base of the user. Here, the base is within the everyday area of activity of the user, for example.

For example, the server controller 33 receives probe data and user information from the information presentation device 10 via the server communication unit 31. The server controller 33 accumulates probe data and user information in the server storing unit 32. The server controller 33 generates data (hereinafter referred to as behavioral pattern data) according to a behavioral pattern of the user based on probe data and user information. Examples of behavioral pattern data are “shops at a supermarket every day in the morning on workdays”, “sometimes eats out with friends during lunchtime on a workday”, and “sometimes visits an amusement facility with family on a day off”. User information includes a log of the user input etc. based on the actions of the user to advertisement information. The server controller 33 updates behavioral pattern data and the advertisement database 321 described below based on the log.

For example, the server controller 33 estimates the destination that is a point to which the user travels, based on a result of a departure point determination, the date and time, and behavioral pattern data. Specifically, for example, when the departure point is the base of the user and it in the morning of a workday, the server controller 33 determines that the destination is a supermarket. For example, when the departure point is the base of the user and it is a day off, the server controller 33 determines that the destination is an amusement facility.

For example, the server controller 33 determines whether the estimated destination is a frequently visited facility. For example, the server controller 33 determines whether the current date and time correspond to a workday or day off of the user (workday/day off determination). The determination of whether the estimated destination is a frequently visited facility and the workday/day off determination are performed based on the current date and time and behavioral pattern data of the user.

For example, the server controller 33 requests advertisement information from the advertisement data server 40 via the server communication unit 31 and receives the advertisement information. Here, the server controller 33 requests advertisement information based on a result of the home/away determination, a result of the destination estimation, a result of the frequently visited facility determination, and a result of the workday/day off determination. The server controller 33 receives advertisement information that conform to the determination results and the estimation result from the advertisement data server 40. Thus, it is possible to acquire advertisement information that takes into consideration the departure point of the user, the destination of the user, the facility frequently visited by the user, and the workday or day off of the user.

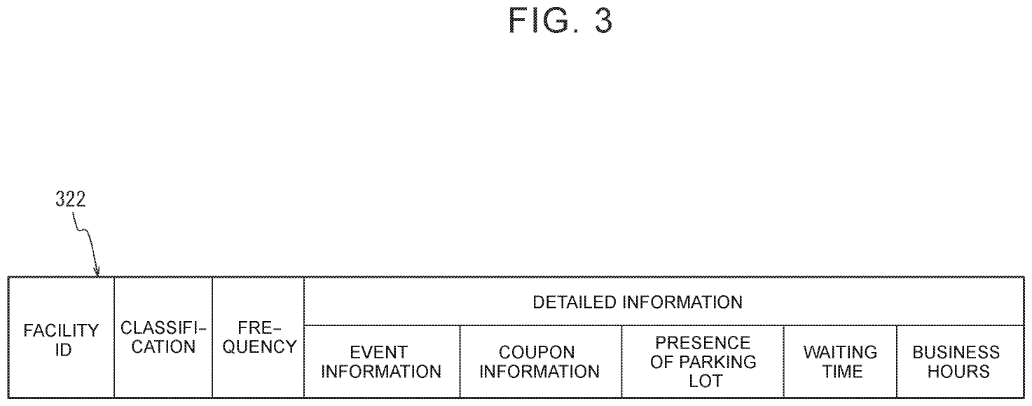

For example, the server controller 33 manages advertisement information received from the advertisement data server 40 through the advertisement database 321. FIG. 3 illustrates a data structure 322 of the advertisement database 321. The advertisement database 321 manages advertisement information for every facility. The advertisement database 321 manages advertisement information for every facility in association with a facility ID, a classification, a frequency, and detailed information. The facility ID is identification information for specifying a facility associated with advertisement information. The classification indicates the type of the facility, such as a “supermarket”, a “restaurant”, or an “amusement facility”. The frequency indicates how often the user visits the facility, and is represented in three levels such as “high frequency”, “medium frequency”, and “low frequency”. The levels are not limited to this, and may be represented in appropriate levels. The detailed information includes event information, coupon information, information about the presence of a parking lot, waiting time, and business hours. Event information includes information about events or promotions at the facility associated with the facility ID. Coupon information includes information about coupons or fliers that can be used for a product or a service provided at the facility associated with the facility ID. Information about the presence of a parking lot include information that indicates whether there is a parking lot at the facility associated with the facility ID. Information about the waiting time include information of the waiting time for entering the facility, the number of groups that are waiting, or reservation information at the facility associated with the facility ID. Information about the business hours include information of business days, business hours, regular closing days, and temporary closing days of the facility associated with the facility ID. Information of the advertisement database 321 is generated based on behavioral pattern data of the user and advertisement information received from the advertisement data server 40.

The server controller 33 extracts advertisement information that should be distributed to the user from the advertisement database 321 and transmits the advertisement information to the information presentation device 10 via the server communication unit 31. The advertisement information includes detailed information of the advertisement database 321. Detailed information of a product or a service in an advertisement is also transmitted to the information presentation device 10 to be presented. Thus, it is possible to determine whether the user is able to smoothly receive the desired product or service when the user travels to a store etc. based on advertisement information.

### Configuration of Advertisement Data Server

As shown in FIG. 1, the advertisement data server 40 has a server communication unit 41, a server storing unit 42, and a server controller 43.

The server communication unit 41 includes a communication module that is connected to the network 50. For example, the server communication unit 41 may include a communication module that conforms to a prescribed wired standard or wireless standard. In the embodiment, the advertisement data server 40 is connected to the network 50 via the server communication unit 41.

The server storing unit 42 includes one or more memory units. The memory units included in the server storing unit 42 may function as a main storage device, an auxiliary storage device, or a cache memory, for example. The server storing unit 42 stores information used for operation of the advertisement data server 40. For example, the server storing unit 42 stores advertisement information of the facilities. For example, the server storing unit 42 may also store a system program, an application program, and a management database etc. Information stored in the server storing unit 42 may be updatable with information acquired from the network 50 via the server communication unit 41, for example.

The server controller 43 includes one or more processors. The server controller 43 controls the operation of the entire advertisement data server 40.

For example, the server controller 43 receives a request for advertisement information from the server 30 via the server communication unit 41. When the request for advertisement information is received, the server controller 43 transmits advertisement information corresponding to the request, to the server 30.

### Operation of Information Presentation System

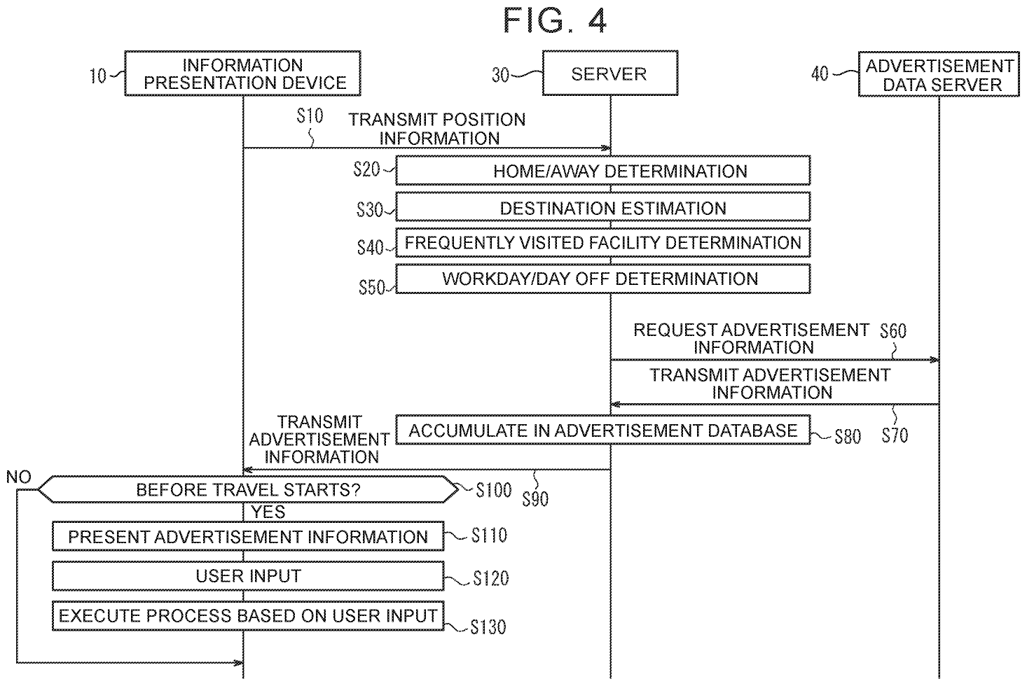

An operation of the information presentation system 1 will be described with reference to a sequence diagram of FIG. 4.

Step S10: The information presentation device 10 transmits position information to the server 30 via the communication unit 11, when the information presentation device 10 starts up.

Step S20: The server 30 performs home/away determination based on position information received from the information presentation device 10.

Step S30: The server 30 estimates the destination that is the point to which the user travels, based on the result of the home/away determination, the date and time, and behavioral pattern data.

Step S40: The server 30 determines whether the estimated destination is a facility that is frequently visited by the user.

Step S50: The server 30 performs workday/day off determination. That is, the server 30 determines whether the current date and time correspond to a workday or day off of the user.

Step S60: The server 30 requests advertisement information from the advertisement data server 40 via the server communication unit 31. Here, the server 30 requests advertisement information based on the result of the home/away determination, the result of the destination estimation, the result of the frequently visited facility determination, and the result of the workday/day off determination.

Step S70: The advertisement data server 40 transmits advertisement information to the server 30 via the server communication unit 41 based on the request for advertisement information.

Step S80: The server 30 accumulates advertisement information received from the advertisement data server 40 in the advertisement database 321.

Step S90: The server 30 transmits advertisement information accumulated in the advertisement database 321 to the information presentation device 10 via the server communication unit 31.

Step S100: The information presentation device 10 determines whether the user has started traveling. If travel has not started (YES in step S100), the process moves on to step S110. In contrast, if travel has started (NO in step S100), the following steps S110 to S130 are not performed and the process is terminated. In other words, the information presentation device 10 does not present advertisement information while the user is traveling.

Step S110: The information presentation device 10 presents advertisement information received from the server 30.

Step S120: The information presentation device 10 receives a user input as an action of the user to advertisement information.

Step S130: When the information presentation device 10 receives the user input, the information presentation device 10 executes processing based on the user input with the controller 16. For example, the information presentation device 10 executes route guidance to the destination associated with advertisement information based on the user input. For example, based on the user input, the information presentation device 10 may also transmit a log of the user input.

As described above, in the information presentation system 1 according to the embodiment, the server 30 estimates the destination of the user and transmits advertisement information associated with the destination to the information presentation device 10. The information presentation device 10 then presents advertisement information to the user before travel starts. While the user is traveling to the destination, the information presentation device 10 restricts presentation of advertisement information more than before travel starts. For example, the information presentation device 10 presents advertisement information before the user starts traveling to the destination, and when the user has started traveling and is on their way, the information presentation device 10 suppresses advertisement information from being presented. Thus, it is possible to reduce the possibility that the user, who is traveling while receiving route guidance through a navigation system etc., feels uncomfortable due to the route guidance being obstructed by advertisement information etc. In other words, it is possible to reduce occurrence of driver distraction by adjusting presentation of advertisement information and output of route guidance etc. while the user is traveling.

The disclosure was described based on the drawings and the embodiment. However, various deformations and modifications can be easily made by those skilled in the art, based on the present disclosure. Accordingly, the deformations and modifications are included in the scope of the disclosure. For example, the functions of the means and steps etc. are relocatable so as not to logically contradict. A plurality of means or steps etc. may be combined into one, or one means or step may be divided into a plurality of means or steps.

For example, in the embodiment described above, another device may have a part of the configuration or the function of the information presentation device 10. For example, another on-board device installed in the vehicle 20 may have a part of the configuration or the function of the information presentation device 10. An external server device may otherwise have a part of the configuration or the function of the information presentation device 10. In this case, the vehicle 20 may communicate with the server device via an on-board communication device such as a DCM installed in the vehicle 20.

In the embodiment, while the user is traveling, the controller 16 of the information presentation device 10 restricts presentation of advertisement information, by stopping presentation of advertisement information by the output unit 14. However, the function of the controller 16 is not limited to this. For example, while the user is traveling, the controller 16 may suppress the output of a part of or all of the detailed information included in advertisement information among advertisement information that has been output before travel starts. For example, if advertisement information has been output by sounds and images before travel starts, the controller 16 may stop the sound output while the user is traveling and output advertisement information only by images. In this way, it is possible to suppress obstruction of the sound guide of route guidance while the user is traveling, for example. For example, when advertisement information is displayed as text or an icon before travel starts, the controller 16 may stop the display by text while the user is traveling and only display the icon. The controller 16 may otherwise display advertisement information by summarizing, shortening sentences, or symbolizing.

In the embodiment, the server controller 33 of the server 30 estimates the destination of the user based on the result of the departure point determination, the date and time, and behavioral pattern data. However, the estimation method of the destination of the user is not limited to this, and an appropriate method may be applied.

In the embodiment, the server controller 33 requests advertisement information based on the result of home/away determination, the result of the destination estimation, the result of the frequently visited facility determination, and the result of the workday/day off determination. For example, based on the determination results, the server controller 33 may be suppressed from requesting advertisement information or transmitting advertisement information to the information presentation device 10. For example, when it is not determined that the departure point is the base of the user and it is estimated that the destination is a home of the user the server controller 33 does not have to request advertisement information associated with the destination. The server controller 33 stops presentation of advertisement information by the information presentation device 10, by not making a request or not transmitting the advertisement information to the information presentation device 10. In this way, output of unnecessary advertisement information on the way home etc. may be suppressed.

In contrast, when it is not determined that the departure point of the user is the base of the user and it is estimated that the destination is the home of the user, the amount of advertisement information presented may be increased. In this way, the user may be allowed to effectively utilize time when returning home. That is, it is possible to improve convenience by changing the amount of advertisement information presented by the information presentation device 10 based on whether the departure point of the user is determined as the base of the user.

The embodiment indicates an example of outputting advertisement information of one facility as advertisement information associated with the destination. However, the embodiment is not limited to this. The information presentation device 10 may output advertisement information of a plurality of facilities associated with the destination. The information presentation device 10 may otherwise output advertisement information of facilities associated with a plurality of destinations. In other words, the information presentation device 10 may present a plurality of pieces of advertisement information with different classifications at the same time. It is possible to improve convenience by presenting the advertisements at the same time in this way. Advertisement information output by the information presentation device 10 may be associated with priorities based on the frequency of visits by the user etc., and a plurality of pieces of advertisement information of higher priorities may be displayed.

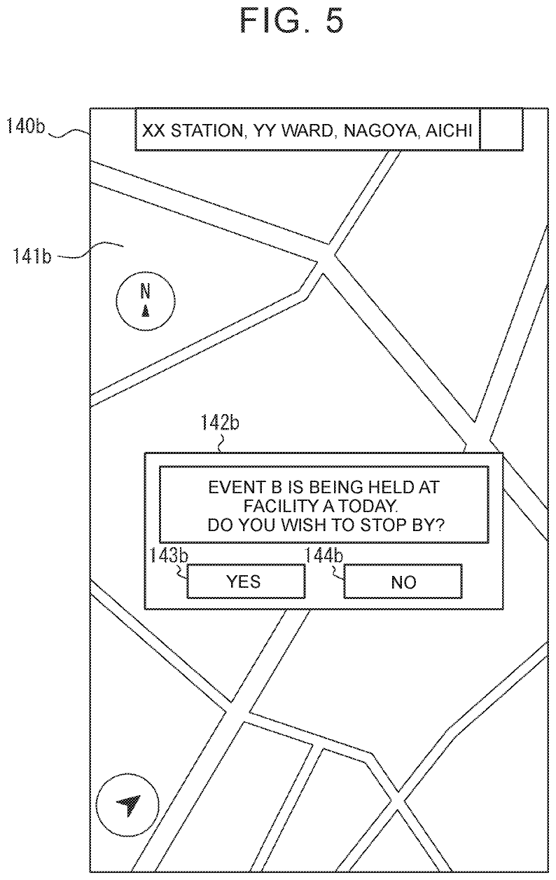

In the embodiment, an example in which the information presentation device 10 is an on-board device was indicated. However, the information presentation device 10 is not limited to this. For example, the information presentation device 10 may be a smartphone. If the information presentation device 10 is a smartphone, position information is transmitted to the server 30 via the communication unit 11 when a program for route guidance installed in the information presentation device 10 starts up. In other words, if the information presentation device 10 is a smartphone, position information is transmitted at the timing when the program starts up, instead of at ACC-ON. FIG. 5 illustrates an example of an advertisement information display screen presented by the output unit 14 when the information presentation device 10 is a smartphone. The output unit 14 displays a display screen 140b, for example. The display screen 140b includes route guidance information 141b including map information and advertisement information 142b. In the example illustrated in FIG. 5, advertisement information 142b includes text according to event information. Similar to the example in FIG. 2, advertisement information 142b includes input buttons 143b, 144b that receive a user input.

Here, in the embodiment, a case in which the information presentation device 10 is an on-board device or a smartphone and the information presentation device 10 is used in a vehicle, was described as an example. However, the information presentation device 10 is not limited to this. For example, the information presentation device 10 may be used outside a vehicle, and means for travel is not limited to a vehicle. For example, the information presentation device 10 may be a smartphone and the means for travel may be walking or train etc. An example in which the information presentation device 10 is formed of one on-board device was indicated. However, the information presentation device 10 is not limited to this, and may be formed of a plurality of the information presentation devices 10. For example, both an on-board device and a smartphone may be used as the information presentation device 10, and the on-board device and the smartphone may each present advertisement information to the user.

The embodiment describes an example in which the information presentation device 10 transmits probe data and user information to the server 30 and the server 30 generates behavioral pattern data based on the probe data and the user information. However, the information presentation device 10 is not limited to this. For example, the information presentation device 10 may generate behavioral pattern data and transmit the generated behavioral pattern data to the server 30 via the communication unit 11.

It is also possible to cause a general-purpose electronic device such as a cellular phone, a smartphone, a tablet terminal, or a mobile computer to function as the server 30 or the advertisement data server 40 according to the embodiment described above. Specifically, a program including processes that realize the functions of the server 30 or the advertisement data server 40 according to the embodiment is stored in a memory unit of an electronic device and the program is read and executed by a processor of the electronic device. Thus, the disclosure according to the embodiment is able to be realized as a program that can be executed by a processor.

Other than those described above, examples of the network 50 of the embodiment include an ad-hoc network, a local area network (LAN), a metropolitan area network (MAN), cellular network, a wireless personal area network (WPAN), a public switched telephone network (PSTN), a terrestrial wireless network, optical network, other networks, or any combination of these networks. Components of the wireless network include an access point (a Wi-Fi access point, for example) and a femtocell etc. The wireless communication device is able to be connected to a wireless network using Wi-Fi (registered trademark), Bluetooth (registered trademark), cellular communication technology or other wireless technologies and technical standards.

In this way, various modes of the content of the present disclosure are able to be realized in many different aspects, and the aspects are all included in the scope of the embodiment.

What is claimed is:

1. An information presentation device comprising:
a communication unit configured to receive advertisement information associated with a destination estimated as a point to which a user travels; and
a controller configured to present the advertisement information to the user before the user starts traveling, the controller being configured to restrict presentation of the advertisement information while the user is traveling more than before travel starts.

2. The information presentation device according to claim 1, wherein
the controller is configured so as not to present the advertisement information while the user is traveling.

3. The information presentation device according to claim 1, wherein
the information presentation device is configured so that an amount of the advertisement information presented by the controller is changed, based on whether a departure point of the user is determined as a base of the user.

4. The information presentation device according to claim 3, wherein
the information presentation device is configured so that the presentation of the advertisement information by the controller is stopped, when it is not determined that the departure point is the base of the user and it is estimated that the destination is a home of the user.

5. The information presentation device according to claim 3, wherein
the information presentation device is configured so that the amount of the advertisement information presented by the controller is increased, when it is not determined that the departure point is the base of the user and it is estimated that the destination is a home of the user.

6. The information presentation device according to claim 1, wherein
the information presentation device is configured so that an amount of the advertisement information presented by the controller is changed, in response to a request for the amount of the advertisement information presented to be changed, which is based on whether a departure point of the user is determined as a base of the user.

7. The information presentation device according to claim 6, wherein
the information presentation device is configured so that the presentation of the advertisement information by the controller is stopped, based on a request for the presentation of the advertisement information to be stopped, when it is not determined that the departure point is the base of the user and it is estimated that the destination is a home of the user.

8. The information presentation device according to claim 6, wherein
the information presentation device is configured so that the amount of the advertisement information presented by the controller is increased, based on a request for the amount of the advertisement information presented to be increased, when it is not determined that the departure point is the base of the user and it is estimated that the destination is a home of the user.

9. The information presentation device according claim 1, wherein
the controller is configured to present the advertisement information to the user after the information presentation device starts up and until travel starts.

10. The information presentation device according to claim 1, wherein
the controller is configured to present a plurality of pieces of the advertisement information with different classifications at the same time.

11. The information presentation device according to claim 1, further comprising an input unit configured to receive a user input for the advertisement information, wherein
the controller is configured to execute, based on the user input, a process of route guidance to the destination associated with the advertisement information.

12. An information presentation method, comprising:
estimating a destination of a user;
receiving advertisement information associated with the destination; and
presenting the advertisement information to the user before the user starts traveling, wherein
presentation of the advertisement information while the user is traveling is more restricted than before travel starts.

13. A non-transitory computer readable medium that stores a program, wherein the program causes an information presentation device to execute processes, the processes including:
receiving advertisement information associated with a destination estimated as a point to which a user travels;
presenting the advertisement information to the user before the user starts traveling; and
restricting presentation of the advertisement information while the user is traveling more than before travel starts.
